(19) United States
(12) Patent Application Publication
(10) Pub. No.: US 2009/0060738 A1
(43) Pub. Date: Mar. 5, 2009

(54) FAN AND MANUFACTURING METHOD THEREOF

(75) Inventors: Meng-Yu CHEN, Taoyuan Hsien (TW); Te-Tsai CHUANG, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/199,525

(22) Filed: Aug. 27, 2008

Related U.S. Application Data
(63) Continuation-in-part of application No. 12/168,565, filed on Jul. 7, 2008.

(30) Foreign Application Priority Data
Aug. 31, 2007 (TW) 96132415

(51) Int. Cl. F01D 25/00; B23P 15/04

(52) U.S. Cl. 415/232; 29/889.4

(57) ABSTRACT

A fan integrated with a sensor is provided and includes a transmission terminal, a frame, a stator, a rotor with the blades. The transmission terminal is electrically connected to the sensor. The frame includes a main body and a supporting structure. The main body forms an inlet, and the supporting structure extends from the main body toward the interior of the inlet and embeds a part of the transmission terminal. Also, a method for manufacturing the above-mentioned fan is disclosed.

### CROSS REFERENCE TO RELATED APPLICATIONS

This Non-provisional application claims priority under 35 U.S.C. §119(a) on Patent Application No(s). 096132415, filed in Taiwan, Republic of China on Aug. 31, 2007. This application is also a continuation-in-part of U.S. application Ser. No. 12/168,565, filed on Jul. 7, 2008, the entire contents of which are hereby incorporated by reference.

### BACKGROUND OF THE INVENTION

1. Field of the Invention

The present invention relates to a fan integrated with a sensor, and in particular to a fan having supporting structures for holding the sensors so as to improve the reliability of the fan.

2. Description of the Related Art

With rapid progress of technology, consumers have more requirements for vehicle electronic equipments, particularly for vehicle air-conditioning systems capable of providing suitable environmental temperature for the driver and passengers.

For traditional vehicle designs for maintaining the same temperature in the vehicle, temperature-sensing conductors are set in the interior of the vehicle which are utilized to transmit temperature signals to sensors embedded in the vehicle body, and a circuit system receives and transmits the detected temperature signals to a vehicle computer to adjust the air-condition system. However, because more heat is transferred to the vehicle body and the interior of the vehicle from outdoors, the detected temperature is often different from the actual temperature inside the vehicle. A fan with temperature sensors is therefore developed. With the fan expelling inside vehicle airflow to pass through the temperature sensors disposed thereon, an actual inside vehicle temperature can be obtained.

Referring to FIG. 1, a conventional fan 1 includes a temperature sensor 10 disposed and suspended in an inlet O. The sensor 10 is connected to a set of terminals 12 via the wires 14 for transmitting temperature signals to an external system. As the sensor 10 is only supported by the wires 14, vibration of the vehicle may cause unstable displacement for the sensor 10. Furthermore, the fan blades 13 may impact the wires 14 or the temperature sensor 10, leading to failure of temperature detection.

### BRIEF SUMMARY OF THE INVENTION

To solve the aforementioned problems, this present invention provides a fan and manufacturing method thereof. The fan includes a supporting structure for holding and fixing a sensor, preventing the sensor from damage and unstable vibration when the vehicle moves so as to improve the stability and the accuracy of the temperature detection.

In an embodiment of the present invention, the fan is integrated with a sensor, including a transmission terminal, a frame, a stator, and a rotor with a plurality of blades. The transmission terminal is electrically connected to the sensor, and the frame includes a main body and a supporting structure. The main body forms an inlet, and the supporting structure extends from the main body toward a center of the inlet and embeds a part of the transmission terminal. The stator and the rotor with the blades are disposed in the frame.

The present invention further provides a method for manufacturing a fan integrated with a sensor. First, a mold is provided, and a transmission terminal is provided and disposed in the mold. Subsequently, a frame is molded by using the mold, wherein the frame forms a supporting structure embedding a part of the transmission terminal during molding. In an embodiment, the frame is made of resin and formed by injection molding, hot melt molding, or compression molding. After forming the frame, a sensor is provided, and the sensor is connected to the transmission terminal by welding.

According to an embodiment of the present invention, the supporting structure is provided for holding, fixing, and embedding a part of the transmission terminal, preventing displacement of the sensor and the damage caused from the blade. Furthermore, as a part of the transmission terminal is embedded by the supporting structure, oxidation of the part of the transmission terminal and signal distortion thereof are also prevented. Hence, the reliability of the fan is improved, and accurate temperature signal transmission from the sensor to the external system is achieved to ensure that the entire air conditioning system work well. Additionally, as the frame is formed and embeds the transmission terminal during the same molding process, production time and costs are reduced.

### BRIEF DESCRIPTION OF THE DRAWINGS

The present invention can be more fully understood by reading the subsequent detailed description and examples with references made to the accompanying drawings, wherein:

FIG. 1 is a schematic illustration of a conventional fan;

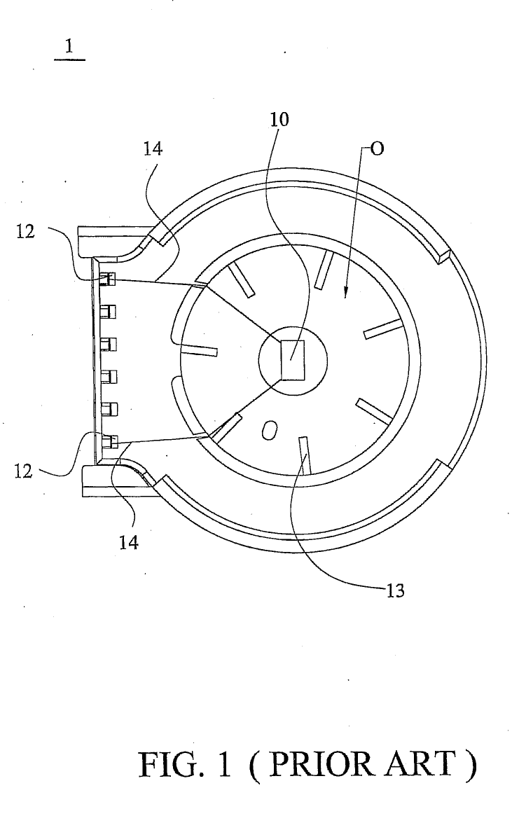

FIG. 2A is a schematic illustration of a fan of an embodiment of the present invention;

FIG. 2B is a top view of FIG. 2A;

FIG. 2C is a exploded diagram of FIG. 2A; and

FIG. 3 is a flow chart illustrating a method for manufacturing a fan of another embodiment of the present invention.

### DETAILED DESCRIPTION OF THE INVENTION

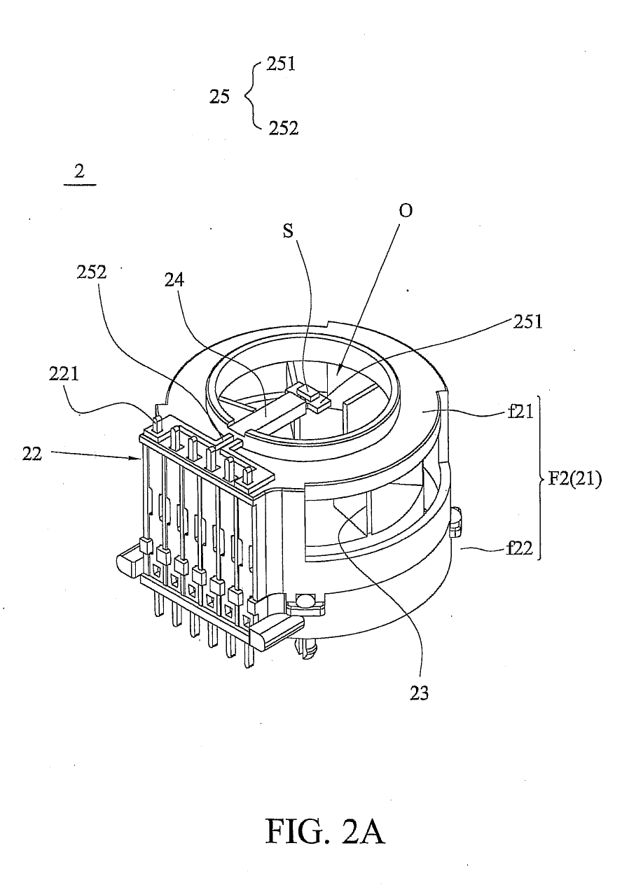

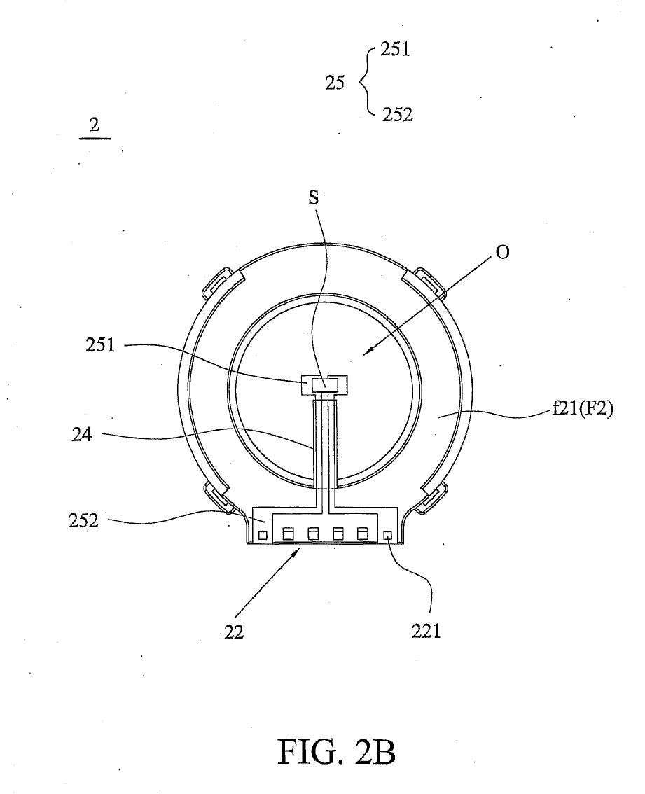

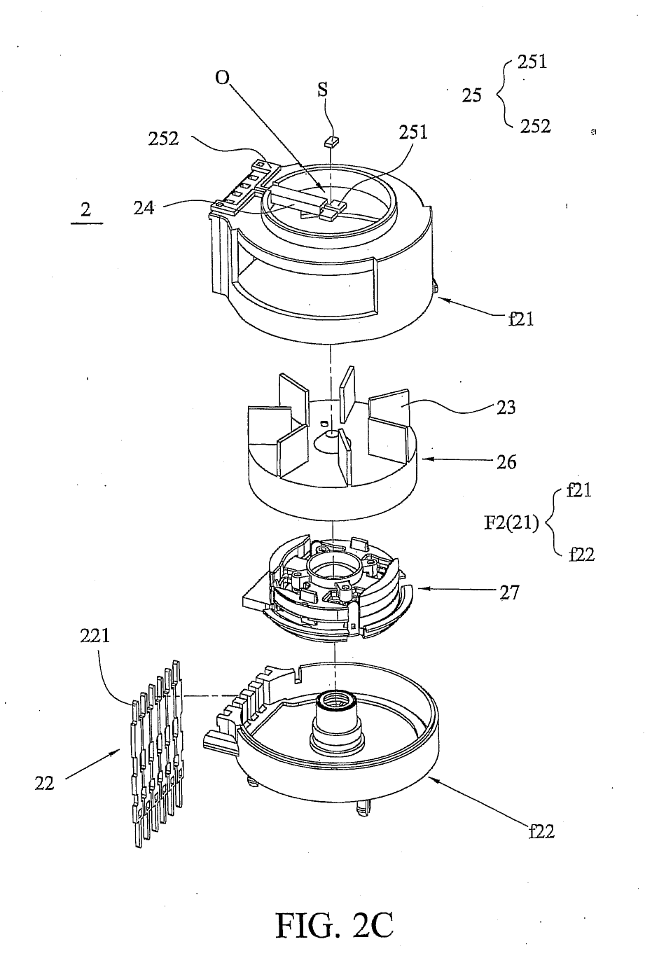

Referring to FIGS. 2A-2C, an embodiment of a fan 2 according to the present invention includes a frame F2 and a transmission terminal 25 electrically connected to a sensor S. As shown in FIG. 2A, the frame F2 has an airflow inlet O to let air flow into the interior of the fan 2. Furthermore, the frame F2 includes a main body 21 and a supporting structure 24. The main body 21 is constituted by an upper main body f21 and a lower main body f22. The upper main body f21 and the lower main body f22 are combined by buckling, for example. The supporting structure 24 extends from the upper main body f21 to the air inlet O and embeds a part of the transmission terminal 25. In another embodiment, the supporting structure 24 and the upper main body f21 of the frame F2 are integrally formed or molded as a single piece. In addition, the length of the supporting structure 24 can be adjusted according to the requirements. As shown in FIG. 2C, the fan 2 further includes a stator 27 disposed in the frame F2 and a rotor 26 with a plurality of blades 23 fixed thereto. Here, the rotor 26 with the blade 23 is rotated by electromagnetic induction to generate airflow.

The sensor S, such as a temperature or humidity sensor, is a surface mount device (SMD) for detecting temperature nearby the sensor S. The transmission terminal 25 includes a flat carrier portion 251 and a transmission portion 252, wherein the sensor S is connected to the flat carrier portion 251 by welding, and the supporting structure 24 embeds most parts of the transmission portion 252 rather than the flat carrier portion 251. The carrier portion 251 includes a U-shaped or hollow rectangular cross section. In another embodiment, the carrier portion includes a first leadwire supporting sub-portion and a second leadwire supporting sub-portion extending and protruding inwardly and radically from two sites of the main body with an angle therebetween (not shown in the figure). A connection portion 22 is disposed on the peripheral of the frame F2 and includes at least two pins 221 electrically connected the transmission portion 252. Hence, temperature signals from the sensor S can be transmitted to an external system through the transmission terminal 25 and the pins 221 of the connection portion 22.

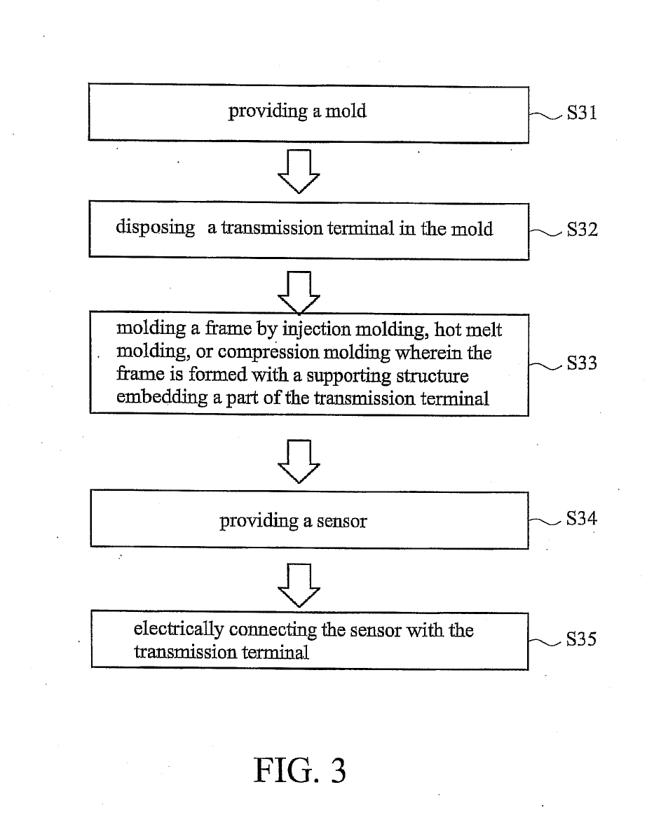

Referring to FIG. 3, a method for manufacturing the fan 2 is provided. First, a mold is provided (S31), and a transmission terminal 25 is disposed in the mold (S32). Subsequently, a frame F2 is molded by using the mold (S33), wherein the frame F2 forms a supporting structure 24 embedding a part of the transmission terminal 25 (most parts of the transmission portion 252) during molding. In this embodiments, the frame F2 is made of resin and formed by injection molding, hot melt molding, or compression molding. After forming the frame F2, a sensor S is provided (S34), and the sensor S is electrically connected to the transmission terminal 25 by welding (S35). Finally, the fan 2 integrated with the sensor S is demonstrated by assembling the stator 27, the rotor 26 with the blade 23, and the frame F2.

Base on the described features of the embodiments, the fan includes a supporting structure for holding, fixing, and embedding a part of the transmission terminal. The supporting structure can prevent displacement of the sensor and damage from the blades. Furthermore, as a part of the transmission terminal is embedded by the supporting structure, oxidation of the part of the transmission terminal and signal distortion thereof are also prevented. Hence, the reliability of the fan is improved, and accurate temperature signal transmission from the sensor to the external system is achieved to ensure that the entire air conditioning system works well. Additionally, as the frame is formed and embeds the transmission terminal during the same molding process, production time and costs are reduced.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation to embed all such modifications and similar arrangements.

What is claimed is:

1. A fan integrated with a sensor, comprising:
a transmission terminal, electrically connected to the sensor;
a frame, comprising:
a main body comprising an inlet; and
a supporting structure, extending from the main body toward the inlet and embedding a part of the transmission terminal; and
a stator and a rotor with a plurality of blades disposed in the frame; wherein the sensor is located close to the inlet.

2. The fan of claim 1, wherein the main body is constituted by an upper main body and a lower main body, and the inlet is disposed at the upper main body.

3. The fan of claim 2, wherein the supporting structure and the upper main body of the frame are integrally formed or molded as a single piece.

4. The fan of claim 1, wherein the sensor is a temperature sensor and/or a humidity sensor.

5. The fan of claim 1, wherein the sensor is a surface mount device (SMD).

6. The fan of claim 1, wherein the transmission terminal comprises a transmission portion and a carrier portion connected thereto, and the carrier portion is flat for holding and being electrically connected to the sensor.

7. The fan of claim 6, wherein the carrier portion comprises a first leadwire supporting sub-portion and a second leadwire supporting sub-portion extending and protruding inwardly and radically from two sites of the main body with an angle therebetween.

8. The fan of claim 6, wherein the carrier portion comprises a U-shaped or hollow rectangular cross section.

9. The fan of claim 6, further comprising a connection portion disposed on a peripheral of the frame, wherein the connection portion comprises at least two pins electrically connected to the sensor through the transmission portion of the transmission terminal, and a signal from the sensor is transmitted through the connection portion to an external system.

10. A method for manufacturing a fan, comprising:
providing a mold;
disposing the transmission terminal in the mold;
forming a frame with a supporting structure embedding a part of the transmission terminal by using the mold;
providing a sensor; and
electrically connecting the sensor with the transmission terminal.

11. The method of claim 10, wherein the sensor is a temperature sensor and/or a humidity sensor.

12. The method of claim 10, wherein the sensor is a surface mount device.

13. The method of claim 10, wherein the transmission terminal comprises a transmission portion and a carrier portion, and the carrier portion is flat for holding and being electrically connected to the sensor.

14. The method of claim 10, wherein the sensor is connected to the carrier portion by welding.

15. The method of claim 13, further comprising a connection portion disposed on a peripheral of the frame.

16. The method of claim 15, wherein the connection portion comprises at least two pins electrically connected to the transmission terminal, and a signal from the sensor is transmitted through the connection portion to an external system.

17. The method of claim 10, wherein the frame is formed by injection molding, hot melt molding, or compression molding.

18. The method of claim 10, wherein the frame and the supporting structure comprise resin.

19. The method of claim 10, wherein the frame further comprises a main body which is constituted by an upper main body and a lower main body, and the upper main body and the supporting structure of the frame are integrally formed as a single piece.

20. The method of claim 19, wherein the upper main body and the lower main body are combined by buckling.
